(19) United States
(12) Patent Application Publication
(10) Pub. No.: US 2023/0420980 A1
(43) Pub. Date: Dec. 28, 2023

(54) POWER CONVERTER SYSTEMS

(71) Applicant: SISU DEVICES LLC, Round Rock, TX (US)

(72) Inventors: Marc Christenson, Round Rock, TX (US); Austin Christensen, Round Rock, TX (US); Jason Dearden, Round Rock, TX (US); Patrick Warby, Round Rock, TX (US); Rachael Dahlman, Round Rock, TX (US)

(73) Assignee: SISU DEVICES LLC, Round Rock, TX (US)

(21) Appl. No.: 18/215,790

(22) Filed: Jun. 28, 2023

Related U.S. Application Data
(60) Provisional application No. 63/356,436, filed on Jun. 28, 2022.

(51) Int. Cl. H02J 9/06; H02J 3/32

(52) U.S. Cl. CPC H02J 9/061; H02J 3/32; H02J 2207/20

(57) ABSTRACT

This disclosure describes systems, methods, and devices for power distribution systems that are capable of receiving and converting a variety of input power options. The power converter system may convert an AC power input into DC power and supplying this to a battery within the system. The power converter system may determine a first power requirement for a load. The power converter system may establish whether the power input is less than the first power requirement for the load. The power converter system may power, responsive to the determination that the power input is less than the first power requirement for the load, the load using a combination of the power input and a supplemental power supply from the battery, wherein the DC power from the battery is converted back to AC power using a phase inverter in the power converter system.

### CROSS-REFERENCE TO RELATED PATENT APPLICATION(S)

This application claims priority to and the benefit of U.S. Provisional Application No. 63/356,436, filed on Jun. 28, 2022, the disclosure of which is hereby incorporated herein by reference in its entirety.

### TECHNICAL FIELD

This disclosure generally relates to systems, methods, and devices for power distribution technologies and, more particularly, for power distribution systems that are capable of receiving and converting a variety of input power options.

### BACKGROUND

In general, power converter systems allow power distribution where a required power output is different from an available power input. Power converter systems are thus capable of powering industrial three-phase 400 VAC or 480 VAC portable equipment, even though power outlets in the area may not be compatible with powering said industrial-phase 400 VAC or 480 VAC portable equipment.

### BRIEF DESCRIPTION OF THE DRAWINGS

FIGS. 1A-1B depicts block diagrams of an example of a power converter system, in accordance with one or more example embodiments of the present disclosure.

FIG. 2 depicts a block diagram of an example of a power converter system, in accordance with one or more example embodiments of the present disclosure.

FIG. 3 depicts a block diagram of an example of a power converter system, in accordance with one or more example embodiments of the present disclosure.

FIG. 4 depicts an illustrative diagram for an example of a power converter system, in accordance with one or more example embodiments of the present disclosure.

FIG. 5 depicts a flow diagram of an illustrative process for a power converter system, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in or substituted for, those of other embodiments. Embodiments set forth in the claims encompass all available equivalents of those claims.

Systems are able to power industrial three-phase 400 Volts Alternating Current (VAC) or 480 VAC portable equipment, for example, a cinema robot arm. However, in locations where only single-phase voltages exist, in locations where only lower voltage three-phase power is available, in locations where only lower voltage outlets can be conveniently accessed, and in locations where no power sources are readily available, an operator may be limited in his or her ability to power such industrial three-phase 400 VAC or 480 VAC portable equipment. Additionally, an operator may be limited in his or her ability to power such industrial three-phase 400 VAC or 480 VAC portable equipment should a typically adequate power source glitch and/or fail.

Currently, this problem is resolved by at least one of the following three methods. First, if a lower three-phase input voltage is available, an operator can hire an electrician to permanently install or create a temporary power distribution transformer setup rated for only one input voltage and phase configuration. However, this solution is inefficient because it is expensive and requires an electrician to install, modify, and verify each setup at each location.

Second, in locations where only single-phase voltages are available, and in locations where three-phase voltages can be difficult to access, an operator can rent or buy an industrial three-phase 400 VAC or 480 VAC generator and connect the industrial three-phase portable equipment to the industrial three-phase 400 VAC or 480 VAC generator. However, these industrial generators are loud and large. Often, these industrial generators take the form of a generator trailer that is towed behind a truck. Further, these industrial generators are inconvenient to use, because the size of the industrial generator requires that the generator stay parked in an appropriate parking location, and lengthy extension cords may need to be used in order to connect the industrial generator to the industrial three-phase 400 VAC or 480 VAC portable equipment.

Third, an operator can upgrade a building or location to enable three-phase 400 VAC or 480 VAC distributions. However, this is a lengthy and expensive process that may involve utility engineers, city planning officials, and other local governmental agencies.

Fourth, an operator can use a power transformer to produce a three-phase 400 VAC or 480 VAC power output even where a power source may not be capable of providing such power. However, the power transformer may be limited to supplying as much power as is provided by a power source. Thus, if the power source is inconsistent, or if a load draws more power than the power source can supply, the load may be temporarily shut down due to limitations of available power. Additionally, the power transformer may only be compatible with certain ranges of power inputs.

It is therefore beneficial for a system, method, and device that can power industrial three-phase 400 VAC or 480 VAC equipment and/or other industrial three-phase equipment having various voltage and/or frequency requirements by leveraging available single-phase AC voltage inputs (including standard domestic and international wall power outlets ranging from single-phase 120 VAC to single-phase 240 VAC) and converting the available single-phase AC voltage inputs to a three-phase higher voltage. It may be further beneficial for a system, method, and device that is capable of outputting power at a frequency that is different from a frequency associated with power input. Such capabilities enable convenient use of the system, method, and device in both domestic and international geographic areas having varied frequency standards. Additionally, it may also be beneficial for a system, method, and device that can power industrial three-phase 400 VAC or 480 VAC equipment and/or other industrial three-phase equipment having various voltage and/or frequency requirements by acting as an uninterruptable power supply, which may reduce risk of damaging sensitive industrial robotic equipment if power is incorrectly applied to the industrial robotic equipment.

Example embodiments of the present disclosure relate to systems, methods, and devices for power converter systems.

In one or more embodiments, a power converter system may receive a power input at a battery charge controller. In some instances, the power input (e.g., AC power input through an AC interface) may be between 100 VAC and 240 VAC (allowing for a 10% margin of error). In one or more embodiments, an operator may be able to select an amount of power that the power converter system can draw from the power input. The power converter system may also determine a power requirement for a load (e.g., from an industrial robot or equipment associated with the robot). The power converter system may then determine whether the power input is less than the first power requirement for the load. If it is determined that the power input is less than the first power requirement for the load, the power converter system may power the load using a combination of the power input and a supplemental power supply from a battery of the power converter system.

In one or more embodiments, the power converter system may determine a second power requirement for the load associated with a second time period. The power converter system may also determine whether the power input is more than or equal to the second power requirement for the load. If it is determined that the power input is more than or equal to the second power requirement for the load, the power converter system may power the load using the power input.

In one or more embodiments, the power converter system may determine a battery charge level associated with the battery. The power converter system may determine whether the battery charge level is less than the maximum charge level associated with the battery. If it is determined that the battery charge level is less than the maximum charge level, the power converter system may charge the battery using the power input.

In one or more embodiments, the power converter system may further include a three-phase inverter. In one or more embodiments, a microcontroller may be communicatively coupled to the three-phase inverter, the battery charge controller, and the battery. In one or more embodiments, a first frequency of the power input may be different from a second frequency of a power output from the three-phase inverter.

The phase inverter (e.g., the three-phase inverter) in the system plays an important role as it connects both to the battery and the microcontroller. The primary responsibility of the phase inverter is to convert the direct current (DC) power that it draws from the battery and the battery charge controller into alternating current (AC) power. This AC power is specifically designed to consistently power a load, which in this context, can be a robot. The robot typically requires an average power that may be less than the AC input power. However, during specific operations, it may need bursts of energy/power that surpass the AC input power. For instance, consider a robot on an assembly line. Most of the time, it performs routine tasks that require a steady but comparatively lower amount of power. This power can be supplied directly by the AC power input, which is transformed into DC power by the battery charge controller and is then converted back to AC power by the phase inverter. However, when the robot needs to execute a high-energy task, such as a sudden acceleration or lifting a heavy object, the power requirement may peak and exceed the AC input power. In such a case, the phase inverter would use the reserve power from the battery to provide the additional power needed, ensuring the robot can perform its task without interruption.

The above descriptions are for purposes of illustration and are not meant to be limiting. Numerous other examples, configurations, processes, etc., may exist, some of which are described in detail below. Example embodiments will now be described with reference to the accompanying figures.

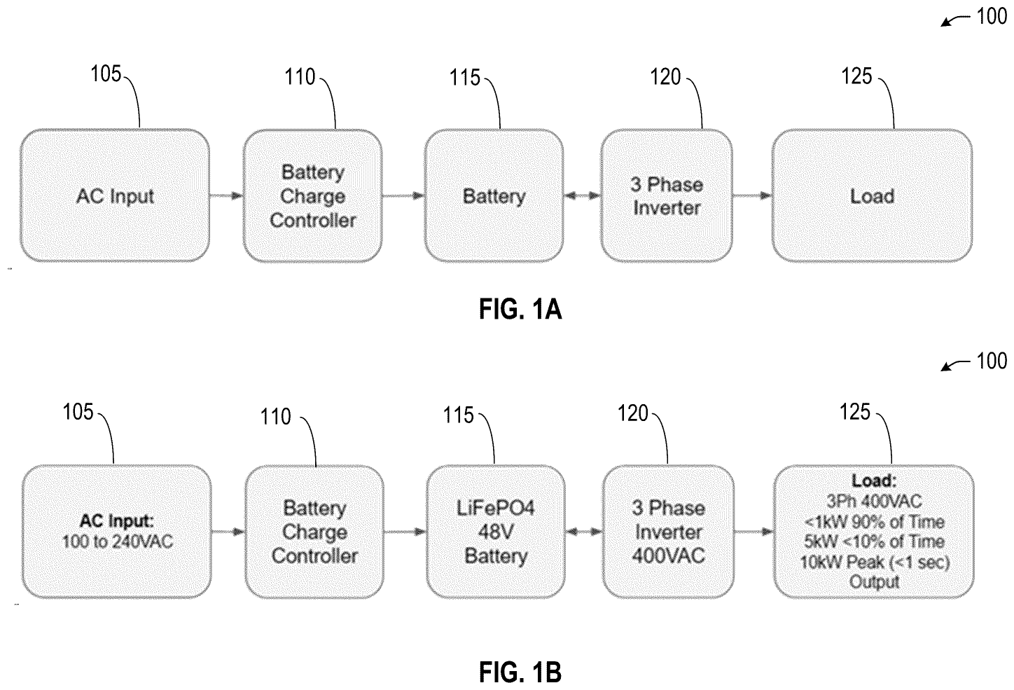

FIGS. 1A-1B are block diagrams of an example of a power converter system, in accordance with one or more example embodiments of the present disclosure.

Referring to FIGS. 1A-1B, there is shown a power converter system 100. As depicted in FIGS. 1A-1B, the power converter system 100 may include a battery charge controller 110 that is configured to be connected to a battery 115. In some embodiments, as depicted in FIG. 1B, the battery 115 may be a lithium iron phosphate (LiFePO₄) 48 Volt battery. The battery 115 may be configured to be connected to a three-phase inverter 120. In some embodiments, as depicted in FIG. 1B, the three-phase inverter 120 may be a 400 Volts Alternating Current (VAC) three-phase inverter. The battery charge controller 110 may be configured to receive an AC input 105 from a power source. In some embodiments, as depicted in FIG. 1B, the AC input 105 may be a power input ranging from a 100 VAC power input to a 240 VAC power input (and allowing for a 10% margin of error). In some embodiments, an operator may be able to select an amount of power that the power converter system 100 can draw from the AC input 105. The three-phase inverter 120 may be configured to be connected to a load 125. In some embodiments, as depicted in FIG. 1B, the load 125 may be a three-phase 400 VAC load. For example, the load 125 may be configured to consume less than 1 kilowatt of power during 90% of operation time, approximately kilowatts during less than 10% of operation time, and a peak of 10 kilowatts in bursts of less than one second. In some embodiments, the load 125 may include industrial equipment.

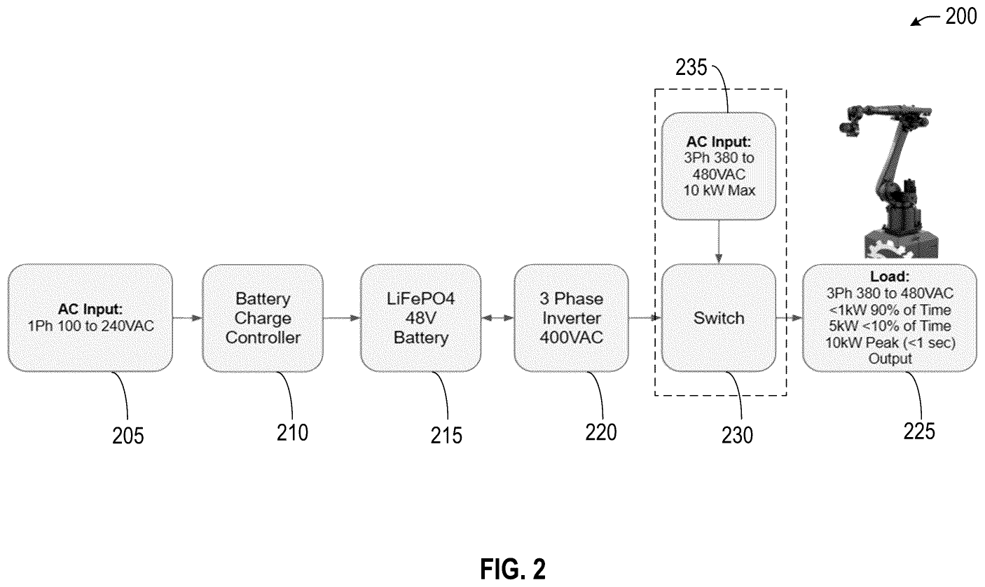

FIG. 2 is a block diagram of an example of a power converter system, in accordance with one or more example embodiments of the present disclosure.

Referring to FIG. 2, there is shown a power converter system 200. As depicted in FIG. 2, the power converter system 200 may include a battery charge controller 210 that is configured to be connected to a battery 215. In some embodiments, the battery 215 may be a LiFePO₄ 48 Volt battery. The battery 215 may be configured to be connected to a three-phase inverter 220. In some embodiments, the three-phase inverter 220 may be a 400 VAC three-phase inverter. The battery charge controller 210 may be configured to receive an AC input 205 from a power source. In some embodiments, the AC input 205 may be a power input ranging from a one-phase 100 VAC power input to a one-phase 240 VAC power input (and allowing for a 10% margin of error). In some embodiments, an operator may be able to select an amount of power that the power converter system 200 can draw from the AC input 205. The three-phase inverter 220 may be configured to be connected to an optional switch 230. The optional switch 230 may then be configured to be connected to a load 225. In some embodiments, the load 225 may be a three-phase 400 VAC load. In case the optional switch 230 is not used, then the three-phase 400 VAC load may be directly connected to the load 225. For example, the load 225 may be configured to consume less than 1 kilowatt of power during 90% of operation time, approximately 5 kilowatts during less than 10% of operation time, and a peak of 10 kilowatts in bursts of less than one second. In some embodiments, the load 225 may include industrial equipment.

In some embodiments, the optional switch 230 may be separately powered by an optional switch AC input 235. In some embodiments, the optional switch AC input 235 may range from a three-phase 380 VAC power input to a three-phase 480 VAC power input. In some embodiments, the optional switch 230 may be a bypass switch, and the load 225 may be configured to accept the range of the optional switch AC input 235.

In certain embodiments, the power converter system 200 may be equipped with at least one battery, whose purpose is to extend the off-mains runtime of the power converter system 200. The term “off-mains” generally refers to operating equipment without being connected to the primary electrical supply grid or ‘mains’. Thus, “off-mains runtime” signifies the duration for which a device can operate independently, without the need for an external power source or being plugged into the electrical grid.

The power converter system 200 may be designed in such a way that a user can easily connect or disconnect this battery. This flexibility allows for the load 225, or the device powered by the system, to operate for extended periods without relying on an external power source or being tethered to a power outlet.

For instance, consider a mobile field hospital in a remote location where connection to the primary power grid isn't always feasible. Medical devices and equipment, like ECG machines, would be the load 225 in this scenario. If these devices are powered by the power converter system 200, they can function off-mains, relying solely on the connected batteries. Consequently, the field hospital could continue to deliver crucial medical services, regardless of the availability of a conventional power source, due to the power converter system's extended off-mains runtime.

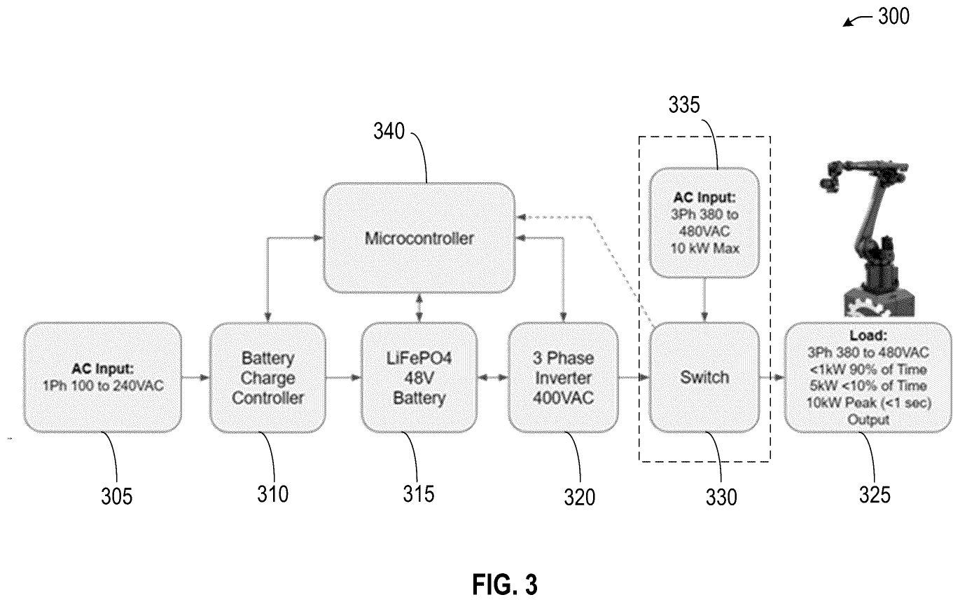

FIG. 3 is a block diagram of an example of a power converter system 300, in accordance with one or more example embodiments of the present disclosure.

In one or more embodiments, the power converter system in discussion has been designed with a wide-range power input. This input, once transformed from AC to DC, is primarily used to charge the battery. When a load is applied, it mainly draws power from the battery, but the power converter system also permits drawing from the battery charge controller, if necessary. This power converter system includes a battery and a battery charge controller. The input power flows through the battery charge controller, which acts as an AC to DC converter with some additional special features on the DC side, and is then used to charge the battery. Both the battery charge controller and the inverter are connected to the same battery terminals, allowing them to charge the battery and draw power from it simultaneously.

The inverter can draw from both the battery and the battery charge controller concurrently. However, the battery charge controller has a power sourcing limit. For example, if the battery charge controller can only source a kilowatt of power from the wall outlet, the inverter can pull up to a kilowatt from the battery charge controller. If more power is needed, such as when a robot requires up to 10 kilowatts, the remaining nine kilowatts can be drawn from the battery.

In a typical scenario, a device (e.g., a robot or equipment associated with a robot or other variable load devices) might only require that full 10 kilowatts at peak times, such as during acceleration. Most of the time, when the robot is moving slowly or idling, it might use only 500 watts, less than what the battery charge controller can provide. This means the battery stays mostly charged, except during peak power requirements. The major benefit to users is the ability to power industrial robots from a standard wall outlet (120-240 VAC), due to the robot not requiring full power constantly.

The battery charge controller's role is essential, functioning to keep the battery charged. If the power converter system remains plugged in, the battery level remains consistently high. However, the power converter system can also be unplugged, allowing the robot to run on battery power alone, a feature some customers might appreciate. Nevertheless, it is expected that most users will keep the system plugged into a 120V-240 VAC outlet for continuous operation.

Furthermore, the power converter system includes a bypass switch, permitting the direct pass-through of power from a source directly into the robot, if an industrial power source is available. An important aspect of the power converter system lies in its ability to be charged with a household current (e.g., 120-240 VAC), even for industrial voltages, a feature not commonly found in similar systems such as large generator replacements. When the load starts to increase, the battery charge controller initially supplies all the required power. Since the battery charge controller needs to output a slightly higher voltage than the battery to charge it, as the load exceeds the battery charge controller's capacity, the voltage starts to dip, and more power is drawn from the battery.

As depicted in FIG. 3, the power converter system 300 may include a battery charge controller 310 that is configured to be connected to a battery 315. In some embodiments, the battery 315 may be a LiFePO₄ 48 Volt battery or any other type of battery. The battery 315 may be configured to be connected to a three-phase inverter 320. In some embodiments, the three-phase inverter 320 may be a 400 VAC three-phase inverter. The battery charge controller 310 may be configured to receive an AC input 305 from a power source. In some embodiments, the AC input 305 may be a power input ranging from a one-phase 100 VAC power input to a one-phase 240 VAC power input (and allowing for a 10% margin of error). In some embodiments, an operator may be able to select an amount of power that the power converter system 300 can draw from the AC input 305.

In one or more embodiments, a microcontroller may be communicatively coupled to the three-phase inverter, the battery charge controller, and the battery.

The three-phase inverter 320 operates as a central link between the battery 315 and the microcontroller 340 within the power converter system. Its fundamental role lies in the transformation of DC power, extracted from the battery 315 and the battery charge controller 310, into AC power. This AC power, regenerated by the phase inverter, is designed to consistently power a load, like a robot, that has an average power consumption lower than the AC input power. Nevertheless, there may be occasions when this robot necessitates peak power that exceeds the AC input power.

An example may be an industrial robot that typically operates on minimal power during most tasks. However, during certain operations such as rapid part assembly or abrupt movements, the robot may require a sudden burst of power. Under these circumstances, the phase inverter is equipped to meet these temporary high-power requirements by tapping into the stored energy from the battery.

The three-phase inverter 320 may be configured to be connected to an optional switch 330. The optional switch 330 may then be configured to be connected to a load 325. In some embodiments, the load 325 may be a three-phase 400 VAC load. For example, the load 325 may be configured to consume less than 1 kilowatt of power during 90% of operation time, approximately 5 kilowatts during less than 10% of operation time, and a peak of 10 kilowatts in bursts of less than one second. In some embodiments, the load 325 may include industrial equipment.

In some embodiments, the optional switch 330 may be separately powered by an optional switch AC input 335. In some embodiments, the optional switch AC input 335 may range from a three-phase 380 VAC power input to a three-phase 480 VAC power input. In case the optional switch 330 is not used, then the three-phase 380 VAC load may be directly connected to the load 325. In some embodiments, the optional switch 330 may be a bypass switch, and the load 325 may be configured to accept the range of the optional switch AC input 335.

A role of the microcontroller 340 is to supervise and report system statuses. The microcontroller 340 may perform diagnoses of issues, or in other words, troubleshooting. It informs users about important system updates such as power fluctuations, potential overcurrent incidents where too much power is being drawn, or when the battery power level is dwindling.

In some embodiments, the battery charge controller 310, the battery 315, the three-phase inverter 320, and/or the switch 330 may be configured to be connected to a microcontroller 340. The microcontroller 340 may be configured to monitor the charge cycle of the battery charge controller 310 and adjust the charge cycle as needed based on any of a user input, a battery status of the battery 315, and/or data collected from the three-phase inverter 320 and/or the switch 330. In some embodiments, the power converter system 300 may be configured to alert an operator of the power converter system 300 if the battery 315 has a low charge or if the battery 315 is at risk of overheating in the near future. The microcontroller 340 may be configured to be connected to a system network (for example, via an Ethernet connection, a Wi-Fi® connection, or a Bluetooth® connection) in order to render data available to other applications, such as a user interface associated with robot control. As an example, if an operator is programming a robotic move at the load 325, the load 325 may be configured to estimate an amount of power needed to dynamically perform the robotic move. The calculated amount of power may then be checked against the amount of power available from the power converter system 300, for example, based on the battery 315 and the three-phase inverter 320. If the estimated power consumption at the load 325 to perform the robotic move may exceed the capabilities of the power converter system 300, the power converter system 300 may be configured to provide a warning to the operator. In some embodiments, an automatic save program and an automatic clean shutdown program may be implemented at the load 325 if a battery level associated with the battery 315 is detected to be low.

In some embodiments, the microcontroller 340 may additionally function as a battery management system that protects the battery 315 from excessive voltages, low voltages, excessive currents, and overheating. The microcontroller 340 may also be capable of balancing voltages between battery cells and/or groups of battery cells. In some embodiments, the microcontroller may additionally ensure that the battery charge controller 310 is outputting maximum power output when required by the three-phase inverter 320. In some embodiments, by monitoring the switch 330, the microcontroller 340 may be configured to be capable of shutting down the battery charge controller 310 and the three-phase inverter 320 in order to keep the battery 315 maintained at an optimal state. In some embodiments, an operator may be able to select an amount of power that the power converter system 300 can draw from an external power source, and the microcontroller 340 may correspondingly adjust constant current settings associated with the battery charge controller 310. In some embodiments, the microcontroller 340 may be configured to direct power inputs from an external power source and the battery 315 based on output needs (i.e., a power requirement at the load 325). The microcontroller 340 thus enables operators to power industrial equipment using an external power source having a lower power input than required by the industrial equipment, because the power converter system 300 is capable of supplying the power requirements of the load 325 during spikes in power drawing. In some embodiments, the power converter system 300 may include more than one microcontroller that is in communication with each other microcontroller.

In some embodiments, although not depicted in FIGS. 1-3, the battery charge controller 310 may be configured to have two modes: constant current and constant voltage. The battery charge controller 310 may be configured to provide DC power and alternate between the constant current and constant voltage modes based on a charge level associated with the battery 315 and a charge profile associated with the battery 315. In some instances, the battery charge controller 310 may be programmed with a single charge profile. In other instances, the battery charge controller 310 may be programmed by a microcontroller (for example, microcontroller 340) with more than one charge profile. In yet other instances, the battery charge controller 310 may be programmed by a microcontroller (for example, microcontroller 340) to reset or adjust its location in a battery charge cycle based on an output power monitored by the microcontroller. In order to do so, the battery charge controller's 310 voltage peak output is modified to be higher than a current battery voltage of the battery 315, thus ensuring that power is drawn from the battery charge controller 310 prior to power being drawn from the battery 315, and power is only supplemented by the battery 315 as needed. If a power requirement from the load 325 decreases from the three-phase inverter 320, the voltage peak output is reduced as necessary, and the battery charge controller 310 may return to either constant current or constant voltage mode, based on its current position in the battery charge cycle. It should be noted that at constant current mode, charge current at the battery charge controller 310 remains constant while charge voltage at the battery charge controller 310 increases over time, while in constant voltage mode, charge voltage at the battery charge controller 310 remains constant while charge current at the battery charge controller 310 decreases over time.

Although not depicted in FIGS. 1-3, it should be noted that a power input to the power converter system 300 may include a single-phase or phase-to-neutral input as well as phase-to-phase input such as from one phase of a three-phase input. Further, although not depicted in FIGS. 1-3, it should be noted that the power converter system 300 may be capable of AC/DC conversion and DC/AC conversion.

Although not depicted in FIGS. 1-3, the power converter system 300 may include other elements, including cooling factors, user indicators for providing notifications (for example, LED indicators, screens, etc.), breakers to protect the power converter system 300 from excessive currents, AC power input connectors, AC power output connectors, filters for AC busses and DC busses within the power converter system 300, an enclosure for containing the power converter system 300 to prevent an operator from directly coming into contact with a high voltage line, and/or sound dampening features to dampen electrical switching sounds and/or audible frequencies within the enclosure (for example, by using acoustic foam to provide sound dampening while maintaining air flow to maintain internal electrical components and wiring at acceptable temperature ranges).

Although not depicted in FIGS. 1-3, it should be noted that the power converter system may be particularly useful for powering loads characterized by consistent lower power usage (for example, power usage that is less than the amount of power provided by the external power source) with only short peaks of high power required. Generally, the power converter system would provide power to the load via an external power source, but, when the required power at the load exceeds the capabilities of the external power source, a battery within the power converter system may supplement the external power source to provide the extra power needed to power the load.

In one illustrative example, although not depicted in FIGS. 1-3, a power converter system may be connected to a wall power outlet capable of providing a power input of 120 Volts Alternating Current (VAC) and 15 Ampere (A). Such a wall power outlet may be capable of providing approximately 1.8 kilowatts of input power to the power converter system. The AC voltage input may be converted via the battery charge controller of the power converter system to a DC voltage of approximately 58 V so as to charge a battery of the power converter system, for example, a 48 V nominal battery. Because of the conversion of the AC voltage input into a DC voltage, the AC power output that is received at the load may be capable of having a different output frequency than the frequency of the AC voltage input. If the battery is fully charged, the DC voltage may remain at approximately 58 V, but the current may be set at 0 A. When a load is undergoing a period of requiring higher power usage, it begins to draw power from the power converter system, and the load may thus draw power from the three-phase inverter, which receives the DC voltage supplied by the battery charge controller. If the load is unable to sufficiently obtain power from the battery charge controller alone, the load may then begin to draw power from the battery. In some instances, an operator of the power converter system may be capable of determining an amount of power to be drawn from the battery and an amount of power to be drawn from the battery charge controller connected to the power source. When the load returns to its lower power usage (for example, while the load is idle), the load may draw a sufficient amount of power from the power source (i.e., a wall power outlet), and the battery may be recharged using input power supplied from the power source.

Although not depicted in FIGS. 1-3, it should be noted that the power converter system may use capacitors and high-power switching transistors in order to create a high-power sine wave output from a DC bus having a low harmonic distortion that is suitable for powering industrial equipment having sensitive electronic components. This may be performed by a three-phase inverter, which may involve a combination of three inverters that work together to generate each of the three phases of output power. Each of the inverters may be configured to draw power from a DC source, such as the battery charge controller or the battery. In one illustrative example, each inverter may be configured to output a single-phase 230 VAC output (which is a common standard voltage output in European countries), which may then be combined and generated 120 degrees out of phase from each other in order to output a three-phase 400 VAC output.

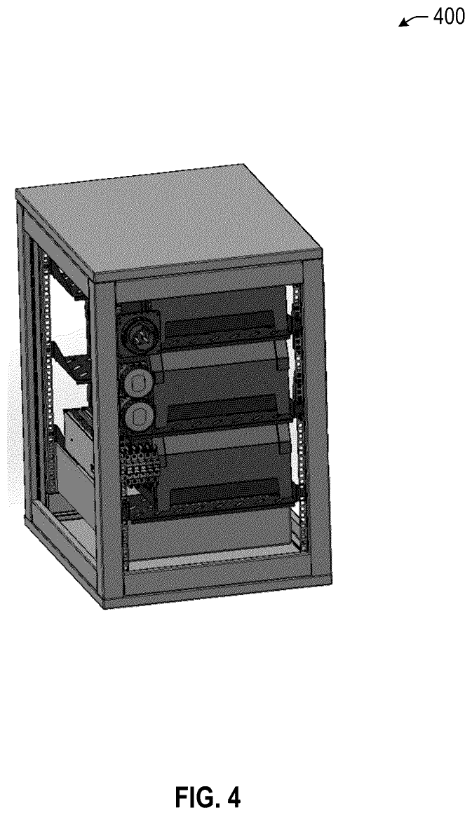

FIG. 4 depicts an illustrative diagram for an example of a power converter system, in accordance with one or more example embodiments of the present disclosure.

Referring to FIG. 4, there is shown a power converter system 400. In some embodiments, the power converter system 400 may operate as a stand-alone device or may be connected (e.g., networked) to other machines. In a networked deployment, the power converter system 400 may operate in the capacity of a server machine, a client machine, or both in server-client network environments. In an example, the power converter system 400 may act as a peer machine in peer-to-peer (P2P) (or other distributed) network environments. The power converter system 400 may be any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer-readable medium containing instructions where the instructions configure the execution units to carry out a specific operation when in operation. The configuring may occur under the direction of the execution units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

Certain embodiments may be implemented in one or a combination of hardware, firmware, and software. Other embodiments may also be implemented as program code or instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the power converter system 400 may include one or more processors and may be configured with program code instructions stored on a computer-readable storage device memory. Program code and/or executable instructions embodied on a computer-readable medium may be transmitted using any appropriate medium including, but not limited to, wireless, wireline, optical fiber cable, RF, etc., or any suitable combination of the foregoing. Program code and/or executable instructions for carrying out operations for aspects of the disclosure may be written in any combination of one or more programming languages, including an object-oriented programming language such as Java, Smalltalk, C++ or the like, and conventional procedural programming languages, such as the “C” programming language or similar programming languages. The program code and/or executable instructions may execute entirely on a device, partly on the device, as a stand-alone software package, partly on the device and partly on a remote device or entirely on the remote device or server.

The power converter system 400 may be capable of functioning as an uninterruptible power source or a backup generator for loads that require industrial power but operate in low voltage residential or commercial power grids, even if an input power source to the power converter system 400 were to fail or be unplugged. The power converter system 400 may be configured to receive a range of power inputs and output a range of power outputs. Acceptable power inputs may include single-phase or phase-to-neutral power outlets, for example, 120 VAC, 208 VAC, or 240 VAC power inputs (and allowing for a 10% margin of error). Acceptable frequencies for power inputs may include 50 Hz and 60 Hz. Acceptable power outputs may include 380 VAC, 400 VAC, 415 VAC, 440 VAC, 460 VAC, or 480 VAC power outputs (and allowing for a 10% margin of error). Acceptable frequencies for power outputs may include 50 Hz and 60 Hz. As an example, the power converter system 400 may be able to output a single-phase 120 VAC power output after receiving a three-phase 480 VAC power input at a battery charge controller of the power converter system 400. The power converter system 400 may be self-sufficient and may be configured to supply power to a load solely using a battery of the power converter system 400 as long as the battery holds sufficient charge. In some instances, the battery of the power converter system 400 may be leveraged to run auxiliary features of the load, for example, transport wheels that may be configured to assist in moving the load from one location to another location. For example, as depicted in FIG. 4, the power converter system 400 may be disposed in a 16U high rack mount configuration.

The power converter system 400 may carry out or perform any of the operations and processes (e.g., the process 500) described and shown below.

It is understood that the above are only a subset of what components the power converter system 400 may include, and that other functions included throughout this disclosure may also be performed by the power converter system 400.

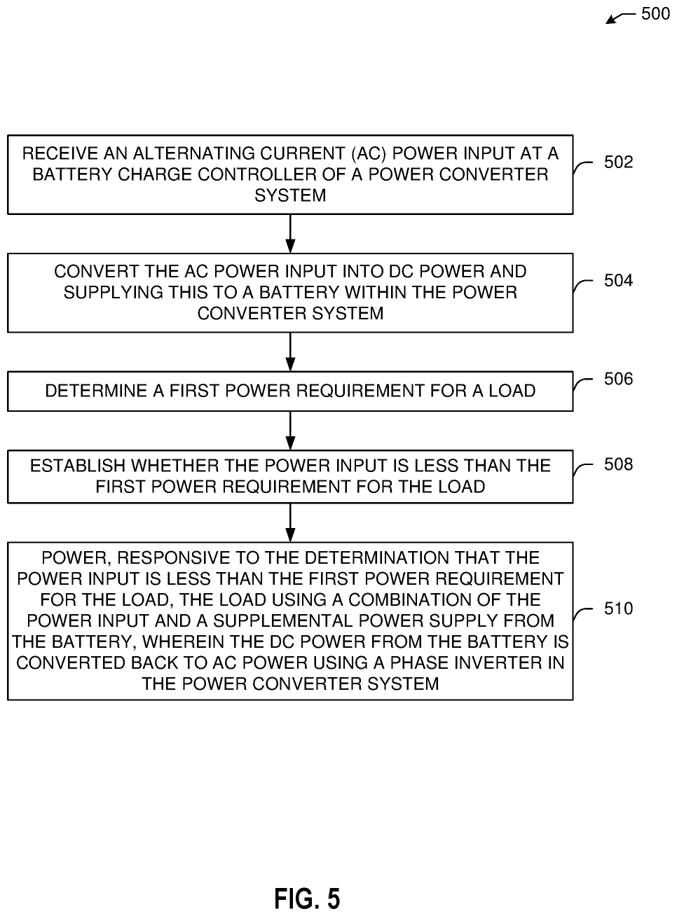

FIG. 5 illustrates a flow diagram of an illustrative process 500 for a power converter system, in accordance with one or more example embodiments of the present disclosure.

At block 502, a power converter system, such as the power converter system 100, may receive an alternating current (AC) power input at a battery charge controller of the power converter system.

At block 504, the power converter system may convert the AC power input into DC power and supplying this to a battery within the system.

At block 506, the power converter system may determine a first power requirement for a load.

At block 508, the power converter system may establish whether the power input is less than the first power requirement for the load.

At block 510, the power converter system may power, responsive to the determination that the power input is less than the first power requirement for the load, the load using a combination of the power input and a supplemental power supply from the battery, wherein the DC power from the battery is converted back to AC power using a phase inverter in the power converter system.

In one or more embodiments, the power converter system may be configured with a microcontroller that continuously tracks a charge status of a battery, adjusting the activity of a battery charge controller based on observed data, thus ensuring the battery remains charged over time. Furthermore, the power converter system may include a battery charge controller with specialized circuitry to adjust the DC power output to suit the charging requirements of the battery. The power converter system may also be equipped with an AC input interface capable of handling a variety of voltage and frequency standards. In managing peak load demands, the power converter system may utilize power from both the AC interface and the battery. Additionally, the power converter system may permit operation off the battery alone when disconnected from the AC input. The power converter system may allow for direct power pass-through from an industrial power source to the load. In terms of power distribution, the power converter system may manage and distribute power to a robot. Finally, the power converter system may be capable of charging from a 120V to 240V range outlet to ensure continuous operation.

It is understood that the above descriptions are for purposes of illustration and are not meant to be limiting.

Various embodiments may be implemented fully or partially in software and/or firmware. This software and/or firmware may take the form of instructions contained in or on a non-transitory computer-readable storage medium or a machine-readable medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read-only memory (ROM), random-access memory (RAM), magnetic disk storage media; optical storage media′ a flash memory, etc.

The term “machine-readable medium” may include any medium that is capable of storing, encoding, or carrying instructions for execution by the power converter 100 and that cause the power converter 100 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The word “exemplary” is used herein to mean “serving as an example, instance, or illustration.” Any embodiment described herein as “exemplary” is not necessarily to be construed as preferred or advantageous over other embodiments.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments of the power converter 100 may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a single input single output (SISO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations. Certain aspects of the disclosure may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.”

The computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A power converter system, the system comprising:
an alternating current (AC) input interface designed to accept and regulate a plurality of AC voltages;
a battery charge controller, connected to the AC input interface, engineered to convert AC power into direct current (DC), and manage a flow of the AC power to charge a battery;
a battery, electrically coupled to the battery charge controller, capable of storing DC power and subsequently supplying the DC power to cater to demands of an external load of a device;
a microcontroller interfaced with all other system elements, programmed to monitor, control, and optimize operation of the power converter system; and
a phase inverter, linked to both the battery and the microcontroller, tasked with the conversion of the DC power drawn from the battery and charge controller back into AC power suitable for continuously powering the external load characterized by an average load lower than the AC input power with peak loads higher than the AC input power.

2. The power converter system of claim 1, wherein the microcontroller is further configured to continuously track a charge status of the battery, adjusting activity of the battery charge controller based on observed data to ensure the battery remains charged over time.

3. The power converter system of claim 1, wherein the battery charge controller comprises specialized circuitry to adjust the DC power output to suit charging requirements of the battery.

4. The power converter system of claim 1, wherein the AC input interface is capable of handling a number of voltage and frequency standards.

5. The power converter system of claim 1, wherein the power converter system manages peak load demands by utilizing power from both the AC interface and the battery.

6. The power converter system of claim 1, wherein the power converter system permits operation off the battery alone when the system is disconnected from the AC input.

7. The power converter system of claim 1, wherein the power converter system allows direct power pass-through from an industrial power source to the load.

8. The power converter system of claim 1, wherein the power converter system manages and distributes power to a robot.

9. The power converter system of claim 1, wherein the power converter system charges from a 120V to 240V range outlet for continuous operation.

10. A method for managing power supply in a power converter system, the method comprising:
receiving, via an alternating current (AC) input interface, an AC power input at a battery charge controller of the power converter system;
converting, using the battery charge controller, the AC power input into DC power and supplying this to a battery within the system;
determining, using a microcontroller, a first power requirement for a load;
establishing, using the microcontroller, whether the power input is less than the first power requirement for the load; and
powering, responsive to the determination that the power input is less than the first power requirement for the load, the load using a combination of the power input and a supplemental power supply from the battery, wherein the DC power from the battery is converted back to AC power using a phase inverter in the power converter system.

11. The method of claim 10, further comprising adjusting activity of the battery charge controller based on a charge status of the battery as monitored by the microcontroller.

12. The method of claim 10, wherein the phase inverter accommodates various AC power standards.

13. The method of claim 10, wherein the determination of the first power requirement considers historical demand patterns and anticipated future usage of the load.

14. The method of claim 10, wherein the battery charge controller comprises specialized circuitry to adjust the DC power output to suit charging requirements of the battery.

15. The method of claim 10, wherein the power input is continuously regulated to handle variations in supply voltage or frequency.

16. The method of claim 10, wherein the microcontroller is further configured to provide status updates and alerts related to the power converter system.

17. The method of claim 10, wherein the load is powered using the supplemental power supply from the battery when the power input fails or is insufficient.

18. The method of claim 10, wherein the phase inverter is designed to deliver AC power to the load with minimal energy loss.

19. A device for managing power supply in a power converter system, the device comprising processing circuitry coupled to storage, the processing circuitry configured to:
receive an alternating current (AC) power input at a battery charge controller of the power converter system;
convert the AC power input into DC power and supplying this to a battery within the system;
determine a first power requirement for a load;
establish whether the power input is less than the first power requirement for the load; and
power, responsive to the determination that the power input is less than the first power requirement for the load, the load using a combination of the power input and a supplemental power supply from the battery, wherein the DC power from the battery is converted back to AC power using a phase inverter in the power converter system.

20. The device of claim 19, wherein the processing circuitry is further configured to adjust activity of a battery charge controller based on a charge status of the battery as monitored by a microcontroller.
